(19) United States
(12) Patent Application Publication
(10) Pub. No.: US 2024/0240413 A1
(43) Pub. Date: Jul. 18, 2024

(54) Electric Apparatus for Screeding Concrete

(71) Applicant: Ligchine International Corporation, Floyds Knobs, IN (US)

(72) Inventors: Peter A. Ligman, Darien, WI (US); Joshua Rocholl, Floyds Knobs, IN (US); Kyle Hohmann, Floyds Knobs, IN (US); Justin Foltz, Floyds Knobs, IN (US); Brad Davis, Floyds Knobs, IN (US)

(21) Appl. No.: 18/414,177

(22) Filed: Jan. 16, 2024

Related U.S. Application Data
(60) Provisional application No. 63/480,032, filed on Jan. 16, 2023.

(51) Int. Cl. E01C 19/42; B60K 1/04; B60K 11/02; B60L 50/60; E04F 21/24; F15B 19/00; F15B 21/0423; H02K 11/25

(52) U.S. Cl. CPC E01C 19/42; B60K 1/04; B60K 11/02; B60L 50/60; E04F 21/241; F15B 19/00; F15B 21/0423; H02K 11/25; B60K 2001/0416; B60L 2200/40; B60L 2240/425; B60L 2260/26

(57) ABSTRACT

An apparatus for screeding concrete to produce a level finished surface includes a frame assembly, a hydraulic extendable boom assembly secured to said frame assembly at a first end and to a screed head at a second end, a hydraulic leveling assembly and an electric power source and power management system for driving a hydraulic system to power the apparatus.

### FIELD OF THE INVENTION

The embodiments described herein relate generally to a system and apparatus for troweling or screeding concrete and specifically to an electrically powered concrete screeding apparatus for screeding a poured concrete surface. The apparatus provides a maneuverable screed that may be easily driven parallel to a poured concrete surface that is being finished and is particularly useful for smaller concrete pours, for example in parking lots, buildings, or high rise structures, commonly termed “upper deck pours”. The screeding apparatus may be operated in enclosed pours without the need to exhaust combustion engine gasses from the space and may also be provided with a screed head having any one or more of a fixed plow, a finish blade and/or an auger, or a plurality thereof, for providing a finished surface to concrete pours. A power management system is provided to extend battery life and screed run time to maximize operational efficiency of the apparatus during use.

### BACKGROUND OF THE INVENTION

In the construction industry uncured concrete is poured to produce a finished surface and it must be quickly and carefully smoothed or screeded, so that when the concrete sets it produces an even, level surface that is relatively free of imperfections and air pockets. Since this finished surface is almost always a foundation for additional construction, machine base applications, or for vertical storage such as warehousing and shelving space, it is highly desirable to produce a surface that is consistently level over its entire area. In large poured concrete areas it is unwieldy and labor intensive to manually “screed”—that is to level and smooth—a poured concrete surface as well as extremely difficult to maintain a consistent finished grade.

A variety of concrete screed or troweling machines have been designed to aid in the screeding of relatively large surface area concrete pours. Most of these machines typically include a screed head comprising a flat troweling surface for contacting the poured concrete that is mechanically extended and retracted across the liquid concrete surface to produce a smooth surface finish. Many prior art devices include internal combustion engines that operate a hydraulic pump and fluid system, and various electro-mechanical systems for leveling the screed head relative to a reference plane such that the finished surface is relatively flat once it is screeded.

A subset of screeding machines are manufactured to suitable to screed smaller concrete pours or to screed pours in areas where access and maneuverability are necessary. Many of these screeds are self-powered and are driven parallel to the area of poured concrete so that a finish blade or screed head that is secured to an extendable boom is moved out over the poured surface, lowered and then slowly retracted across the surface being finished to provide a smooth, level finished surface. These prior art machines may have leveling systems that position the screed head upwardly and downwardly during the screed pass to provide a relatively level finished surface. Maneuverability and ease of operability of these devices is paramount since the machines are often required to screed around and between support columns, HVAC ducting, and plumbing and electrical chases, and sometimes need to be able to access areas through doors or door frames.

Many of these prior art machines are conventionally powered by an internal combustion engine, which supplies the requisite power to move the machine, and extend, retract, and continuously level the screed head during a screeding pass. Often the engine is used to power a hydraulic pump that supplies pressurized hydraulic fluid used to power most of the screed functions. For example, many screed booms are operated by hydraulic cylinders, as is the leveling operation of the screed head, and even the drive wheels may be powered by hydraulic motors.

Prior art screed systems that used an internal combustion engine (gasoline or diesel) for power obviously emit pollutants in the form of gas from the engine required to provide power to the screed. In enclosed areas the exhaust must be removed from the environment in order to comply with various governmental safety regulations and provide a safe and healthy working environment for operators and others working in the area. Of course ducting or removing machine exhaust is time consuming and expensive. Furthermore, internal combustion engines are often quite noisy, and are prone to vibration, which is anathema to a machine that is attempting to produce a level finished surface.

Accordingly, there is a need in the art for a system and method screeding and troweling concrete that provides a consistently level finished surface with a minimum of mechanical and electrical system complexity, and that has the ability to quickly maneuver a screed in enclosed spaces during a pour, and offer reduced or zero emissions

### SUMMARY OF THE INVENTION

The apparatus and embodiments described herein provide a screed for leveling and finishing a poured concrete surface that may include or incorporate a rigid frame assembly on which a both an electric motor and a concomitant battery power supply is mounted. The motor supplies power via a conventional output shaft to a hydraulic assembly, also mounted on the frame assembly. The hydraulic assembly may typically include a pump for pressurizing hydraulic fluid and a plurality of electrically actuated control valves (not shown) for supplying pressurized hydraulic fluid to a plurality of components required to operate the screed. Furthermore, the hydraulic assembly may also include a radiator and an electrically operated cooling fan to enable control of the working hydraulic fluid's temperature over a wide range of operating conditions.

In various non-limiting aspects of the invention the hydraulic assembly may further comprise a control system which may include a microprocessor, data memory, inputs and outputs, a wireless transceiver or transceivers, thermal sensors to monitor hydraulic fluid temperature, and requisite wiring to electrically connect the control system to the plurality of hydraulic control valves. Furthermore, throughout the specification the operation of hydraulic cylinders will be understood to be effected through the use of a conventional hydraulic system, comprising electrically actuated hydraulic valves and a control system for operating said valves, as is known to one of ordinary skill in the art.

### BRIEF DESCRIPTION OF THE DRAWING FIGURES

In the drawings, like reference characters generally refer to the same parts throughout the different views. Also, the drawings are not necessarily to scale, emphasis instead generally being placed upon illustrating the principles of the invention.

FIG. 1 is a block diagram of a control system for an electric concrete screed in accordance with some embodiments;

FIG. 2 is a perspective view of a concrete screed in accordance with some embodiments;

FIG. 3 is a perspective view of a concrete screed in accordance with some embodiments:

FIG. 4 is a rear view of a concrete screed in accordance with some embodiments:

FIG. 5 is a side view of a concrete screed in accordance with some embodiments:

FIG. 6 is a partial perspective end view of a concrete screed in accordance with some embodiments; and

FIG. 7 is a top view of a concrete screed in accordance with some embodiments.

### DETAILED DESCRIPTION OF THE PREFERRED EMBODIMENT(S)

Numerous variations and modifications will be apparent to one of ordinary skill in the art, as will become apparent from the description below. Therefore, the embodiments described are not limited to the specific implementations discussed herein.

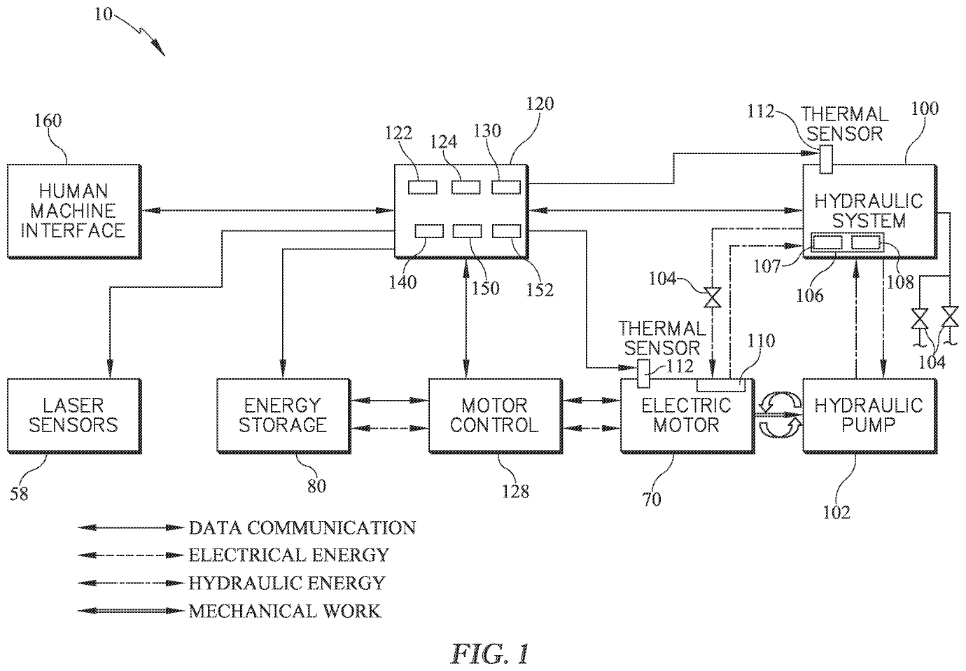

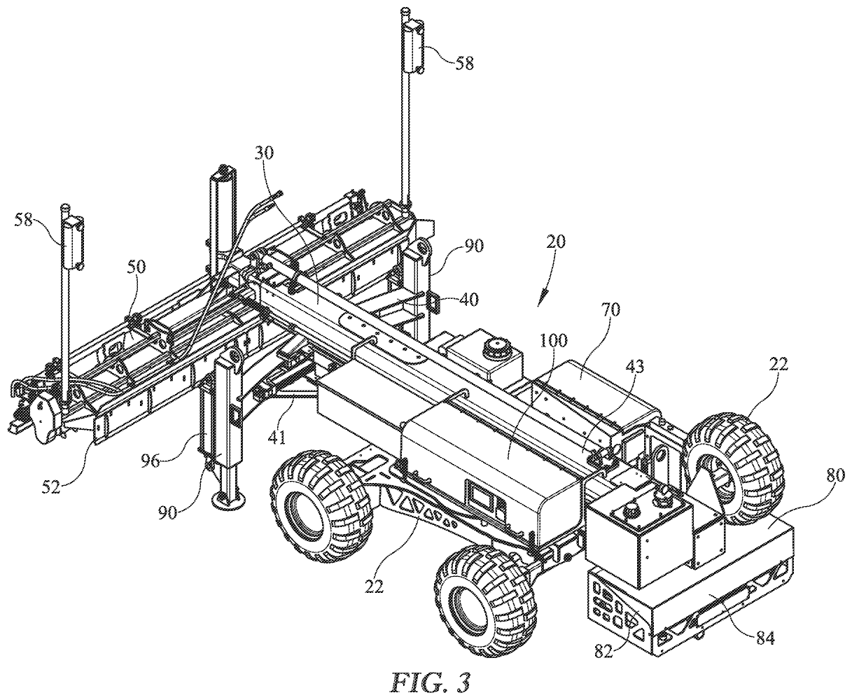

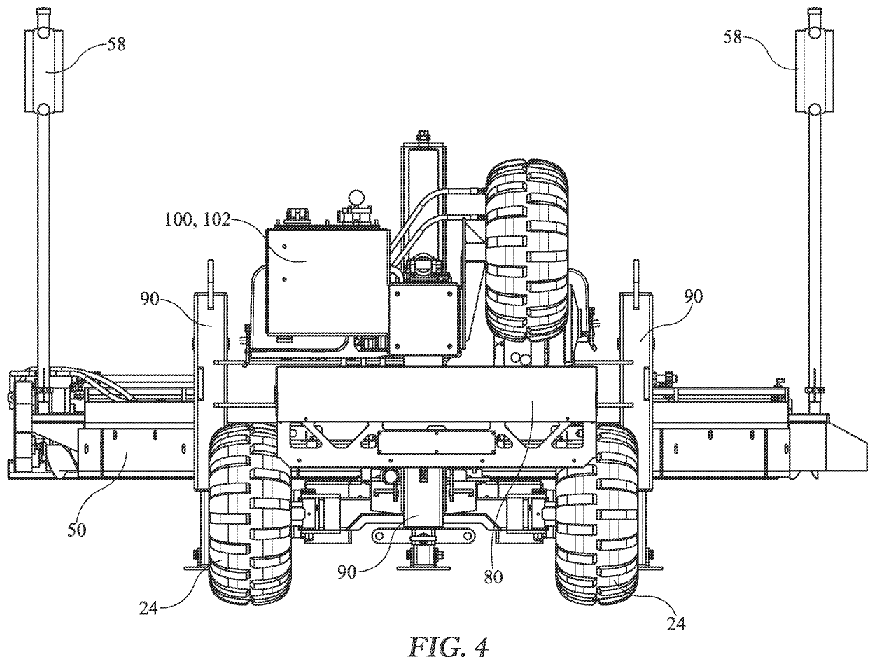

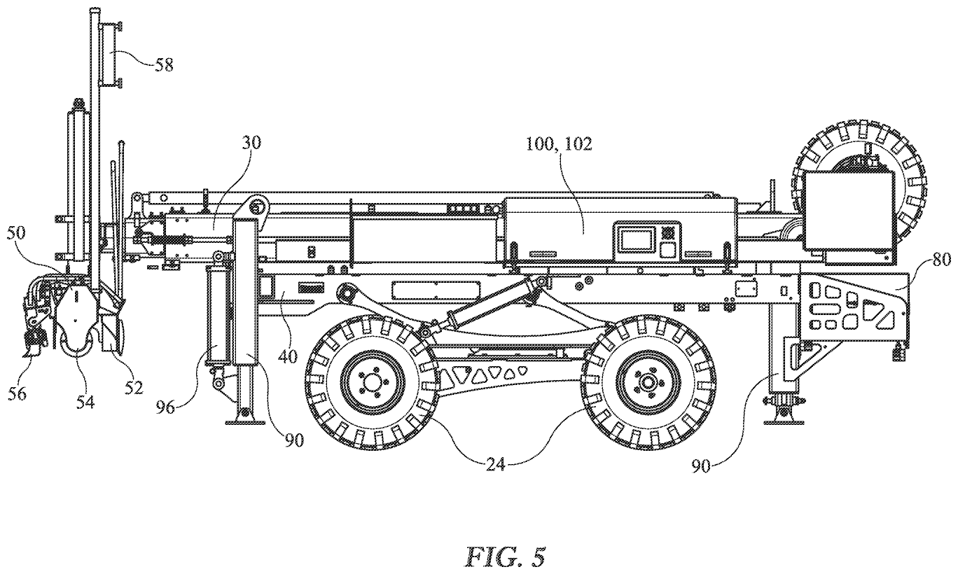

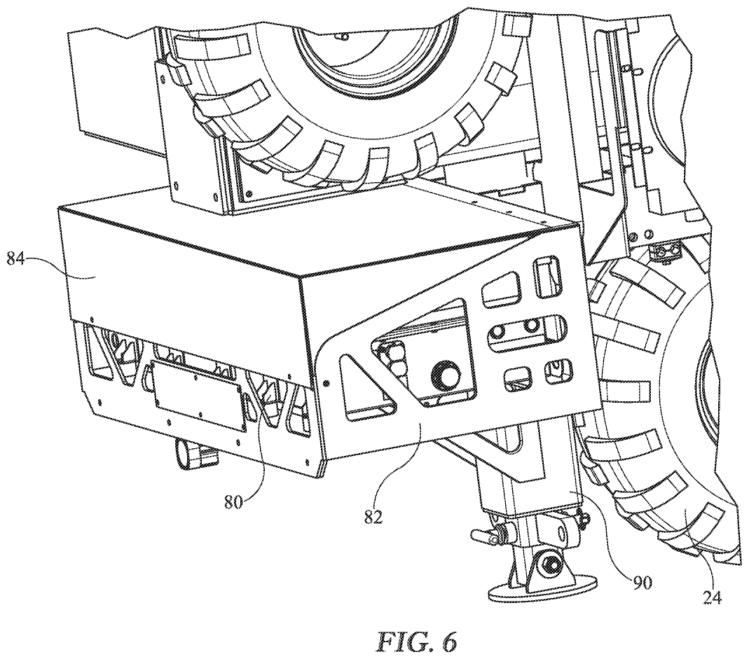

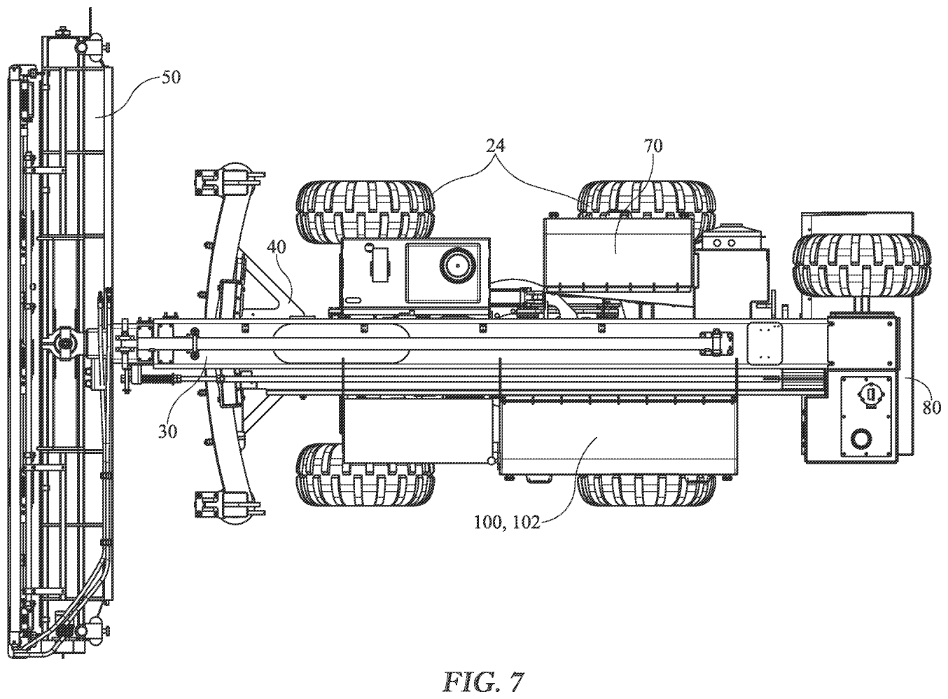

Referring now to drawing FIGS. 1-7, and in accordance with some aspects and embodiments, the system 10 described herein overcomes the aforementioned difficulties in the prior art by providing an electrically powered concrete screed apparatus 20, known in the art as a concrete screed 20, or simply a screed 20, having a telescopic boom assembly 30 and a rigid frame assembly 40 to which boom assembly 30 is adjustably secured. One of ordinary skill in the art will recognize that a wide variety boom assemblies 30 and/or frame assemblies 40 may be employed in the construction of screed apparatus 20 without departing from the scope thereof. Screeds 20 may be provided in various configurations, for example, turret-type screeds, box-frame screeds, or center frame screeds, without departing from the embodiments disclosed herein.

In some aspects and embodiments a unitary screed head assembly 50 that may include at least one of a plow 52, an auger 54 or augers 54, and a finish blade 56 is secured to a distal end 32 of boom assembly 30. In some aspects and embodiments screed head assembly 50 may include only one finish blade 56 or only one or two augers 54, a roller or rollers (not shown), or any combination of these smoothing members without departing from the scope of the embodiments described. In some embodiments auger 54 may be rotated by operation of a hydraulic or electric motor.

In some exemplary embodiments an electrical power system 70 is provided, for example an electric motor 70 supplied by an electrical power storage system, for example a source such as a battery 80 or batteries 80. Motor 70 includes an output shaft 72 coupled to a hydraulic assembly 100, including a hydraulic pump 102 that operates to supply pressurized hydraulic fluid to a plurality of components necessary to operate screed 20 via a plurality of electrically actuated control valves 104. In the embodiments depicted herein boom assembly 30 is capable of being extended and retracted by operation of hydraulic pressure supplied by pump 102 and concomitant control valves 104.

Additionally, in some aspects a screed drive assembly 22 may include a plurality of screed 20 drive wheels 24 that may be operated by hydraulic motors (not shown) that are supplied pressurized hydraulic fluid by operation of pump 102. In some embodiments electric motors, or even driven gear or chain systems may be provided to drive wheels 24 and thus to screed 20. Furthermore, drive assembly 22 and its associated mounting undercarriage may in some aspects of the invention be rotatably mounted directly to frame 40 to provide maneuverability to the assembly.

Boom assembly 30 is secured at a distal end thereof to screed head 50 that operates to smooth and level a poured concrete surface, screed head 50 having a plurality of laser sensors or leveling eyes 58 secured or appended thereto that are used to level boom assembly with respect to a reference plane, thereby providing a level finished concrete surface as the screed head is retracted. In various embodiments of the present invention the laser sensors 58 may comprise laser transmitters that emit light that is received by a receiver thereby providing the ability to adjust screed head 50 to a reference plane, as is known in the art.

In further aspects and embodiments a plurality of adjustable stabilization legs 90 are secured in a generally vertical orientation to frame assembly 40 at a plurality of points around the perimeter thereof. As shown in the drawing Figures, in one exemplary embodiment two opposed legs 90 are secured to frame assembly 40 at a forward end 41 thereof, as described in more detail below, while a single leg 90 is secured to a rear end 43 of frame assembly 40. One of ordinary skill in the art will understand that the number and positioning of legs 90 around frame assembly 40 may be varied without departing from the scope of the embodiments. Each leg 90 is further secured to a hydraulic cylinder 96 which is also secured to frame 40 at a point, and that is utilized to level boom assembly 30 with respect to a reference plane, thereby leveling entire screed apparatus 10 as well as screed head 50. Hydraulic cylinders 96 are also supplied with pressurized hydraulic fluid by operation of pump 102. This feature provides an extremely level finished concrete surface, since boom 30 and screed head 50, once leveled, are unable to move with respect to a desired reference plane.

Referring to FIG. 1, in some embodiments system 10 includes a control system 120 which may include a microprocessor 122, data memory 124, inputs 130 and outputs 140, a wireless transceiver 150 or transceivers, communications interfaces 152, for example an Ethernet communications interface 152, and requisite wiring to electrically connect control system 120 to screed 20 mechanical and propulsion components such as electric motor or motors 70, hydraulic pump 102, hydraulic control valves 104, laser sensors 58, thermal sensors, electric control valves, switches, and all the requisite control and feedback components of screed 20. Furthermore, an operator interface 160 or human machine interface (HUI) 160 is operatively coupled to control system 120 to provide ease of monitoring and control of all aspects of screed 20 operation. In some embodiments HUI 160 may comprise a general purpose computer with a keyboard or keypad and a display, or a touch screen or equivalent display device, or a smart phone or similar digital device. Microprocessor 122 may be provided with suitable instructions to enable control system 120 to operate screed 20 in its various functions as described herein. HUI 160 may be operatively coupled to control system 120 either wirelessly, or through a hardwired connection without departing from the scope of the various embodiments.

HUI 160, or an operator display screen that operates as a portion or component of HUI 160, may be mounted or secured to screed 20 or in other embodiments may be a handheld HUI 160 that is not mounted on screed 20, but rather is capable of being carried by an operator or user as the screeding process proceeds. In these embodiments HUI 160 may comprise a tablet or handheld computer or even a smart phone or the like, and further may employ wireless communications with control system 120 via wireless transmitter/transceivers 150.

In accordance with some embodiments control system 120 may further include a motor controller 128 that communicates with and receives commands from microprocessor 122 and thereby controls operation of electric motor 70 as screed 10 operates. Motor controller 128 may be one of many commercially available motor controllers 128.

In some aspects and embodiments system 10 electrical power source, battery or batteries 80 may comprise a high electric charge capacity battery 80, such as a rechargeable lithium ion deep cycle battery system and a concomitant power control and management system. A wide variety of battery 80 types may be employed in various embodiments without departing from the scope of the embodiments described, and are mainly only limited by their ability to supply sufficient current and cycle times to operate screed 20, depending upon the operational requirements of a specific screed 20. In some embodiments a plurality or series of batteries 80 may be employed.

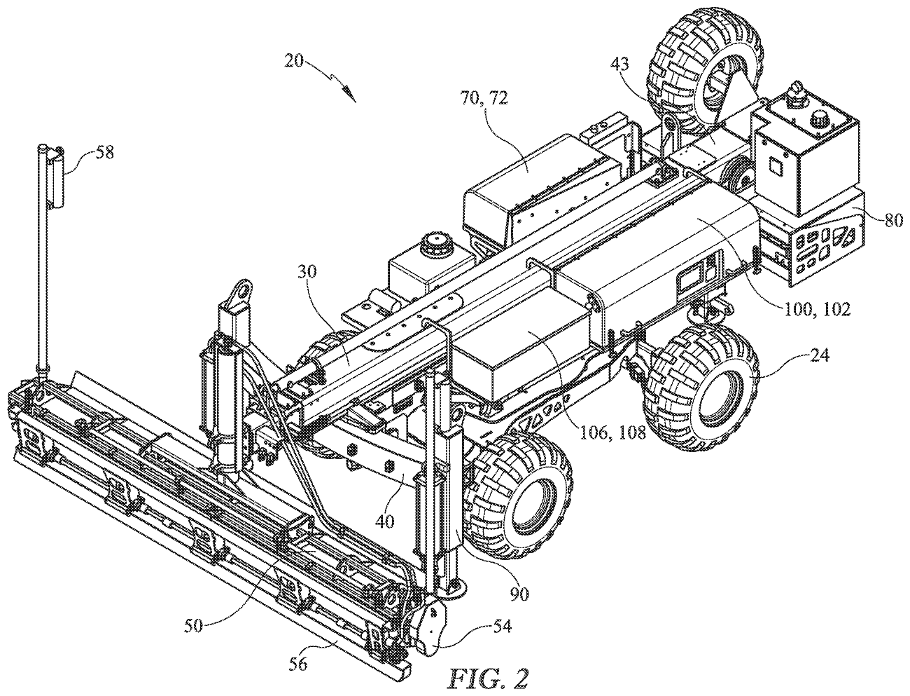

In some embodiments as shown in drawing FIGS. 2-6 and in accordance with various aspects, concrete screed apparatus 20 battery 80 may be advantageously mounted on rear portion 43 of frame 40, and is protected from below by a frame portion 82 and/or a cover 84. As best seen in FIGS. 2-5 in some embodiments battery 80 may be secured to screed 20 rearwardly of rear wheels 24, thereby providing a counterweight or counterbalance to screed head 50 owing the inherent weight of battery 80, particularly when boom 30 is extended out for a screeding pass. Additionally, the mounting location of battery 80 at rear 43 of the screed 20 also optimizes the center of gravity of screed 20, particularly when it is operating a screed pass. Furthermore, the rear location of battery 43 provides for ease of access for an operator, making it easy and quick to connect a charging cord, or even remove and replace battery or batteries 80 if necessary. These embodiments enable the relatively even distribution of screed 20 weight across the entire screed head 50, thereby providing for more accurate and energy-efficient leveling of screed 20 and more even finished surfaces.

In various aspects and embodiments, hydraulic assembly 100 may further comprise a cooling system 106 that may include a hydraulic fluid radiator 107 and electric fan 108, whereby the hydraulic fluid supplied by pump 102 is in fluid communication with a cooling jacket or heat exchanger 110 positioned around and secured to electric motor 70. Electric fan 108 may be operatively coupled to an output 140 of control system 120. In some embodiments a plurality of radiators 107, fans 108, and heat exchangers 110 may be used to cool the hydraulic fluid.

Control system 120 further includes a plurality of thermal sensors 112 such as thermocouples or RTDs, or the equivalent, on both hydraulic system 100 and electric motor 70 to provide the ability to actively cool electric motor 70 using hydraulic fluid for different modes of screed 20 operation. Thermal sensors 112 include concomitant signal outputs operatively coupled to control system 120 inputs 130 such that temperature of both electric motor 70 and hydraulic system 100 fluid may be continuously monitored by control system 120.

In various aspects and embodiments control system 120 is provided with suitable instructions (or code) to monitor thermal sensors 112 and control, via an output 140, a valve or valves 104 supplying cooling hydraulic fluid to electric motor 70. Accordingly, the temperature of motor 70 can be monitored and controlled by control system 120 for optimal thermal efficiency during screed 20 operation. Furthermore, the temperature of the hydraulic working fluid can be monitored by control system 120 reading a concomitant hydraulic fluid temperature sensor 112, and thus controlled for optimal efficiency during all phases of screed 20 operation. The use of the working hydraulic fluid as a cooling fluid for electric motor 70 greatly reduces the complexity of construction of screed 20, since a separate cooling system that may include an additional pump, radiator, wiring, and of course tubing or piping, does not need to be employed to enable efficient thermal operation of screed 20 as is the case with machines having conventional internal combustion engines.

In some exemplary but non-limiting embodiments control system 120 may be suitably programmed with an instruction set to provide various functions and capabilities to screed 20. For example, control system 120 may incorporate a power management system that may be provided by suitable programming instructions, whereby screed 20 may be operated in a plurality of operational modes for managing battery 80 power depending upon its current state of use. Control system 120 may monitor how screed 20 is being used by monitoring control system 120 inputs 130 and outputs 140 to automatically switch between modes of operation. Alternatively, control system 120 may enable an operator to manually select a mode of screed 20 operation by selecting a suitable button or icon provided on HUI 160. Buttons or icons on HUI 160 may be provided for each operational mode disclosed herein, or in some cases combinations of operational modes.

For example, control system 120 may monitor inputs 130 and output 140 to determine when screed 20 is running—in other words when motor 70 is on and hydraulic pump 102 is operable), but boom 30 is not being operated and screed 20 is not being moved by operation of its hydraulic wheel 22 motors. When these screed 20 operating conditions exist control system 120 may automatically initiate or switch to a “standby mode” of operation, whereby all screed 20 systems remain active but battery 80 power usage is absolutely minimized. In some embodiments standby mode may include shutting down electric motor 70 and hydraulic pump 102 after a predetermined time period has expired without further operational commands provided to screed 20, as determined by continued monitoring of inputs 130 and outputs 140 by control system 120. In this situation, control system 120 automatically starts motor 70 and pump 102 when requested by an operator through any selection requiring machine use via HUI 160.

In accordance with further aspects and embodiments control system 120 may operate screed 20 in a “cooling mode” whereby hydraulic pump 102 and/or a hydraulic control valves 104 provide reduced temperature hydraulic fluid to electric motor 70 to reduce or maintain its temperature in a predetermined optimal range. In some exemplary embodiments when electric motor 70 temperature is determined to be too high or above a predetermined high motor temperature threshold, hydraulic cooling system 106 may be utilized to reduce motor 70 temperature by actuating electric cooling fan 108 to force cooling air across hydraulic fluid radiator 107, thereby reducing the temperature of hydraulic working fluid being supplied to electric motor 70 by operation of a control valve 104 actuated by control system 120. Cooling mode operation may in some embodiments be activated responsive to thermal sensor 112 of electric motor 70 reaching a predetermined temperature set point, above which the cooling mode is entered.

In yet further aspects and embodiments control system 120 may also provide a a “heating mode” when thermal sensor 112 monitoring the hydraulic fluid of hydraulic system 100 determines the hydraulic fluid temperature to be below an optimal predetermined range. In these embodiments control system 120 monitors the hydraulic system 100 thermal sensor 112 and when the temperature is below a predetermined threshold operating temperature indicating low temperature hydraulic fluid, control system 120 provides additional heat to the hydraulic fluid by suitable hydraulic pump 102 operation, for example by idling pump 102 continuously without supplying hydraulic fluid to any components, or “deadheading” the pump. Heating mode operation may in some embodiments be automatically activated by control system 20 based on the temperature sensed by thermal sensor 112 of hydraulic system 100.

Additionally, and in accordance with some embodiments control system 120 may also include a “driving mode” whereby hydraulic wheel 22 motors are the primary source of power consumption of screed 20. When wheel 22 operation is requested by an operator through HUI 160, control system 120 can automatically optimize battery 80 usage by operating electric motor 70 at a predetermined rpm range designed to optimize both hydraulic fluid pressure and battery 80 drain and performance in typical screed “driving” situations. This feature of system 10 greatly enhances and improves battery 80 life by limiting peak current output of battery 80 during movement of screed 20 from either around a pour site or when loading or unloading during transport.

In some embodiments control system 120 may include a “screeding mode” of operation when screed 20 is engaged in finishing a poured concrete surface and boom 30 extension and retraction and screed head 50 operation are the primary sources of electrical power consumption. In one exemplary embodiment when a screed operation is requested by an operator through HUI 160, control system 120 senses boom 30 operation and/or screed head 50 leveling operation by monitoring control system 120 outputs 140 to boom 30 and screed head 50. Once the screed operation is sensed, control system 120 automatically optimizes battery 80 operation by providing motor control instructions to electric motor 70 to operate only at a predetermined rpm range designed to optimize both hydraulic system 100 fluid pressure and battery 80 drain and performance in a typical screed pass operation. In this embodiment control system 120 operates to maximize battery 80 operational time during use of screed 20 such that screed 20 may operate for as long as possible before recharging must occur.

It should further be noted that in certain embodiments control system 120 may utilize two modes simultaneously where necessary. For example, cooling mode can be utilized with either screeding mode or drive mode, since cooling the hydraulic fluid while operating the machine is sometimes desirable, and in fact necessary. Standby mode and heating mode are only used exclusive of other operational modes. In some embodiments control system 120 prohibits an operator from selecting standby or heating modes when another operational mode is actively being used as sensed by control system 120.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one.” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B.” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” “secured,” and “mounted,” and variations thereof herein are used broadly and encompass direct and indirect connections, couplings, and mountings. In addition, the terms “secured” and “mounted” and variations thereof are not restricted to physical or mechanical connections or couplings.

While the present invention has been shown and described herein in what are considered to be the preferred embodiments thereof, illustrating the results and advantages over the prior art obtained through the present invention, the apparatus disclosed herein is not limited to those specific embodiments. Thus, the embodiments shown and described herein are to be taken as illustrative only and other embodiments may be selected without departing from the scope of the apparatus, as set forth in the claims appended hereto.

We claim:

1. An apparatus for screeding concrete to produce a level finished surface comprising:
a frame having a front end and rear end, said frame having a plurality of spaced vertically oriented stabilization legs secured to a front end and a rear end thereof, and said frame being mounted on a plurality of powered drive wheels;
an extendable and retractable boom assembly secured to said frame at a first end and to a screed head at a second end;
a controller having a processor, a data memory, a plurality of inputs and outputs for receiving and accepting signals respectively, and an operatively coupled human machine interface for operating said apparatus, said human machine interface having at least one visual display operatively coupled thereto;
an electric power system operatively coupled to said controller for powering said apparatus; and
a hydraulic system operatively coupled to said electric power system for pressurizing hydraulic fluid.

2. The apparatus as claimed in claim 1 wherein said electric power source comprises:
a rechargeable battery; and
an electric motor powered by said rechargeable battery, said motor having an output shaft.

3. The apparatus as claimed in claim 2 wherein said hydraulic system comprises:
a hydraulic pump operatively coupled to the output shaft of said electric motor for pressurizing said hydraulic fluid; and
a plurality of hydraulic lines and hydraulic valves for supplying said hydraulic fluid to said apparatus.

4. The apparatus as claimed in claim 3 comprising:
a hydraulic cooling system having a radiator in fluid communication with said hydraulic pump and an electric fan for forcing air over said radiator; and
a plurality of thermal sensors operatively coupled to said controller, at least one of said thermal sensors being an electric motor thermal sensor positioned to monitor a temperature of said electric motor and at least one of said thermal sensors being a hydraulic fluid thermal sensor positioned to monitor a temperature of said hydraulic fluid.

5. The apparatus as claimed in claim 3 wherein said battery is mounted proximate a rearward portion of said frame, thereby providing a counterweight to said boom assembly and said screed head.

6. The apparatus as claimed in claim 4 comprising:
a heat exchanger operatively secured to said electric motor, said heat exchanger in fluid communication with said hydraulic cooling system, whereby said hydraulic fluid operates to cool said electric motor.

7. The apparatus as claimed in claim 6 comprising:
a control valve in fluid communication with said heat exchanger and operatively coupled to said controller for controlling the flow of hydraulic fluid through said heat exchanger.

8. The apparatus as claimed in claim 7 comprising:
a suitable instruction set for said controller, whereby said instruction set comprises a power management system for said apparatus.

9. The apparatus as claimed in claim 6 wherein said power management system comprises:
a standby mode, a cooling mode, a driving mode, a screeding mode, and a heating mode, and wherein said modes may be selected automatically by said controller, or selected manually through operation of said human machine interface.

10. The apparatus as claimed in claim 9 wherein said standby mode includes comprises:
stopping the operation of said electric motor and said hydraulic pump when said controller has not received an operational command for a predetermined time period.

11. The apparatus as claimed in claim 9 wherein said cooling mode comprises:
responsive to a predetermined hydraulic fluid temperature as sensed by said hydraulic fluid thermal sensor, operating said electric fan to force air over said radiator, thereby reducing said hydraulic fluid temperature.

12. The apparatus as claimed in claim 11 wherein said cooling mode comprises:
responsive to a predetermined high electric motor temperature as sensed by said electric motor thermal sensor is operating said electric fan to force air over said radiator, thereby reducing said hydraulic fluid temperature.

13. The apparatus as claimed in claim 9 wherein said heating mode comprises:
responsive to a predetermined hydraulic fluid temperature as sensed by said hydraulic fluid thermal sensor, operating said electric motor and said hydraulic pump to pressurize said hydraulic fluid, thereby increasing said hydraulic fluid temperature.

14. The apparatus as claimed in claim 9 wherein said driving mode comprises:
responsive to a sensed movement of said apparatus by said control system monitoring said powered drive wheels, operating said electric motor at a predetermined rpm range to optimize power consumption during driving of said apparatus.

15. The apparatus as claimed in claim 9 wherein said screeding mode comprises:
responsive to a sensed movement of said boom assembly and screed head by said control system, operating said electric motor at a predetermined rpm range to optimize power consumption during a screeding pass of said apparatus.

16. The apparatus as claimed in claim 9 wherein said power management system permits an operator to select a desired one of said modes through use of said human machine interface.

17. The apparatus as claimed in claim 9 wherein said power management system automatically selects a mode of operation of said apparatus depending upon the operation of said apparatus.

18. An apparatus for screeding concrete to produce a level finished surface comprising:
a frame having a front end and rear end, said frame having a plurality of spaced vertically oriented stabilization legs secured to a front end and a rear end thereof, and said frame being mounted on a plurality of powered drive wheels;
an extendable and retractable boom assembly secured to said frame at a first end and to a screed head at a second end;
a controller having a processor, a data memory, a plurality of inputs and outputs for receiving and accepting signals respectively, and an operatively coupled human machine interface for operating said apparatus, said human machine interface having at least one visual display operatively coupled thereto;
a rechargeable battery;
an electric motor powered by said rechargeable battery, said motor having an output shaft;
a hydraulic pump operatively coupled to the output shaft of said electric motor for pressurizing said hydraulic fluid;
a hydraulic cooling system having a radiator in fluid communication with said hydraulic pump and an electric fan for forcing air over said radiator; and
an electric motor thermal sensor positioned to monitor a temperature of said electric motor and a hydraulic fluid thermal sensor positioned to monitor a temperature of said hydraulic fluid.

19. The apparatus as claimed in claim 18 wherein said battery is mounted proximate a rearward portion of said frame, thereby providing a counterweight to said boom assembly and said screed head.

20. The apparatus as claimed in claim 19 comprising:
a heat exchanger operatively secured to said electric motor, said heat exchanger in fluid communication with said hydraulic cooling system, whereby said hydraulic fluid operates to cool said electric motor.

21. The apparatus as claimed in claim 20 wherein said control system includes a plurality of operational modes comprising:
a standby mode, a cooling mode, a driving mode, a screeding mode, and a heating mode, and wherein said modes may be selected automatically by said controller, or selected manually through operation of said human machine interface.
